(19) United States
(12) Patent Application Publication
(10) Pub. No.: US 2026/0210304 A1
(43) Pub. Date: Jul. 23, 2026

(54) METHOD FOR CONTROLLING A MOTOR BRAKE OF AN INTERNAL COMBUSTION ENGINE

(71) Applicant: ZF Friedrichshafen AG, Friedrichshafen (DE)

(72) Inventor: Simon Geiger, Oberteuringen (DE)

(73) Assignee: ZF Friedrichshafen AG, Friedrichshafen (DE)

(21) Appl. No.: 19/139,516

(22) PCT Filed: Nov. 20, 2023
(86) PCT No.: PCT/EP2023/082312

§ 371 Date: Jun. 16, 2025

(30) Foreign Application Priority Data
Dec. 16, 2022 (DE) 10 2022 213 784.1

(51) Int. Cl. F02D 13/04; F02D 9/06; F02D 13/02; F02D 41/02

(52) U.S. Cl. CPC F02D 13/04; F02D 9/06; F02D 13/0246; F02D 41/022; F02D 2200/101; F02D 2200/501

(57) ABSTRACT

The present invention relates to a method for controlling a motor brake of an internal combustion engine of a powertrain of a motor vehicle (10). In one step, the motor brake is activated. In another step, a reversing process (42) is detected. A step is then carried out in which a deactivation time of the motor brake is determined on the basis of the detected reversing process and in another step, the motor brake is deactivated at the deactivation time (46). The invention additionally relates to a controller (12).

### RELATED APPLICATIONS

This application claims the benefit under 35 U.S.C. § 371 as a U.S. National Phase Application of application no. PCT/EP2023/082312, filed on 20 Nov. 2023, which claims the benefit of German Patent Application no. 10 2022 213 784.1 filed on 16 Dec. 2022, the contents of which are hereby incorporated herein by reference in their entireties.

### TECHNICAL FIELD

The present invention relates to a method for controlling a motor brake of an internal combustion engine. The invention also relates to a controller for controlling a motor brake of an internal combustion engine.

### PRIOR ART

In a motor vehicle, a motor can be used to cause deceleration, for example, in addition to or as an alternative to a service brake. This causes the motor to go into thrust state, which can increase the motor speed. There is a limit thrust speed that must not be exceeded. Otherwise, damage to the powertrain may occur. If this limit thrust speed is exceeded, the transmission automatically shifts to neutral to protect itself. In order to reliably cause the deceleration by the motor, a motor brake can be provided. The motor brake can be a function wherein the motor or powertrain causes additional deceleration that is not caused purely by friction. The motor brake can significantly increase the deceleration achieved compared to a motor that is simply not driven, thereby preventing the limit thrust speed from being exceeded.

For this purpose, the motor brake is controlled depending on the motor speed, for example by taking into account specified speed thresholds. For example, when decelerating in thrust state, the motor brake is activated when a maximum speed is exceeded. For example, the motor brake is only deactivated again when the maximum speed or a different minimum speed is not reached or when the motor returns to a drive state.

When using the motor brake, there may be a deceleration before drive power can be applied to the motor again. This can lead to restrictions, particularly when changing direction by a reversing process, which is usually preceded by a deceleration of the vehicle. This may cause the vehicle's performance to fall below a desired and normally available level. In exceptional cases, the motor may even stall due to the reversing process and a deceleration with the motor brake activated.

### SUMMARY OF THE INVENTION

A first aspect of the invention relates to a method for controlling a motor brake of an internal combustion engine of a powertrain of a motor vehicle. A motor brake can be a function of the internal combustion engine itself or a separate device that causes additional deceleration by means of the internal combustion engine. For example, the motor brake can be used to influence valve control or even the exhaust system such that the deceleration of the motor vehicle by the internal combustion engine is increased. An internal combustion engine can be part of a powertrain. An internal combustion engine can be a combustion engine that converts chemical energy into mechanical work. To this end, fuel can be injected into a combustion chamber. A powertrain in a motor vehicle can, for example, provide drive power and braking power for the motor vehicle. The powertrain can include the internal combustion engine, a transmission, and, for example, an output in the form of tires. Optionally, the powertrain can also be designed to provide a power take-off. The motor vehicle can be designed, for example, as a passenger car, work machine, or agricultural machine. For example, the motor vehicle can be designed as a wheel loader.

The method includes a step of activating the motor brake. Activating the motor brake can cause additional deceleration. When the motor brake is activated, the internal combustion engine may be in a thrust state, for example, In the thrust state, a shaft of the internal combustion engine can be driven by the rolling vehicle. In its thrust state, the internal combustion engine can cause the motor vehicle to decelerate, which can be intensified by the activated motor brake. In the thrust state, for example, the internal combustion engine does not provide any drive power. In a drive state, the internal combustion engine can power the motor vehicle and, for example, accelerate it. An injection process can take place in the drive state. In this process, fuel can be injected into a combustion chamber of the internal combustion engine. In the drive state, the shaft of the internal combustion engine can be driven by a combustion process. In this drive state, the motor brake is deactivated, for example. The motor brake can be activated depending on the speed of the internal combustion engine and, alternatively or additionally, on a control of the motor vehicle, for example a predetermined speed. The motor brake can also be controlled depending on the speed of the internal combustion engine and, alternatively or additionally, the control of the motor vehicle, for example to change the amount of deceleration caused by the motor brake. For example, the motor brake may have a first deceleration stage and a second deceleration stage, wherein the second stage decelerates more strongly than the first stage.

The method includes a step of detecting a reversing process. For example, the reversing process can be detected by the driver's control of the motor vehicle. For example, the driver can operate a control element, such as a direction selector lever, to request the reversing process. By detecting this operation, the reversing process can be recognized, for example as imminent. However, the reversing process can also be predicted and thus detected on the basis of vehicle status information such as driving speed, position in a work area, and selected gear. A reversing process can be a change in the direction of travel, for example, from reverse to forward. A reversing process may involve actuating a reversing device of the motor vehicle, for example a reversing device of its transmission. For the reversing process, for example, one clutch of the reversing device can be opened and then another clutch of the reversing device closed. The reversing process may cause a reversal of the direction of rotation on an output shaft of the powertrain.

The method includes a step of determining a deactivation time of the motor brake depending on the detected reversing process. For example, the deactivation time can be determined relative to specific times in the reversing process, such as clutch actuation, pivoting of a hydrostat, or the start of an injection process. The deactivation time can refer to a timing at which the motor brake is switched off. This allows the motor brake to be controlled in terms of time depending on the reversing process instead of depending on the motor speed. This prevents any unwanted influence on the reversing process and, in particular, any reduction in the performance of the powertrain during reversing or shortly thereafter.

The method includes a step of deactivating the motor brake at the deactivation time. At the deactivation time, the speed of the internal combustion engine may still cause the motor brake to be activated in a conventional motor brake control system. This means that the motor brake can now be deactivated early on in order to provide full drive power for reversing in good time. This allows for the fact that the motor brake itself may have a certain reaction time. For example, several hundred milliseconds may elapse between a signal to deactivate the motor brake and the brake actually being completely deactivated. In addition, due to combustion processes and alternative or additional pressures in the internal combustion engine itself, even after the motor brake has been completely deactivated, an injection process to provide normal drive power cannot take place immediately, for example because a backflow in the exhaust system impedes the combustion process. This can also be taken into account. This prevents the motor brake from being deactivated too late, which could result in excessive motor braking, for example. Accordingly, the method can prevent a reduction in acceleration capacity during a reversing process due to a previously active motor brake.

The method may also provide for the motor brake to be deactivated when the motor speed falls below a motor speed threshold value. For example, the driving behavior of the motor vehicle may indicate that the motor brake should be deactivated even before the deactivation time. In this case, the motor brake can be deactivated using the usual control system, as this means that there is no longer any restriction on the drive power during the reversing process.

In another embodiment of the method, it is contemplated that the determination of the motor brake deactivation time is made as a function of a deceleration time between the motor brake deactivation and an admissibility of a start of an injection process in the internal combustion engine, as well as a start time of the injection process in the internal combustion engine during the reversing process. The deceleration time can be a period of time between the deactivation signal for the motor brake and actual deactivation. Alternatively, the deceleration time can be a period of time between the deactivation signal for the motor brake and the admissibility of the start of the injection process in the internal combustion engine. Alternatively, the deceleration time can be a period of time between the actual deactivation of the motor brake and the admissibility of the start of the injection process in the internal combustion engine. The start of the admissibility of the injection process may be a time at which fuel may again be fed into the combustion chamber of the internal combustion engine either at all or in a manner not limited by the motor brake. Injection can involve feeding fuel into the combustion chamber, for example with atomization and air supply. The start time of the injection process in the internal combustion engine during the reversing process can correspond to a time at which drive power is again required by the internal combustion engine during the reversing process. This ensures that the motor brake is deactivated in good time for unrestricted acceleration during the reversing process. For example, the deactivation time can be set so that it is the deceleration time before the start time of the injection process.

In a further embodiment of the method, it is provided that the determination of the deactivation time of the motor brake is made dependent on a deactivation delay time of the motor brake. For example, it may be known how long it takes for a flap in the exhaust system of the motor brake to adjust. The deactivation time can thus take this adjustment time into account. The deactivation delay time can correspond to an inertia of the motor brake in response to control signals.

In a further embodiment of the method, it is provided that the deactivation time is determined such that the internal combustion engine is still in a thrust state when the motor brake is deactivated. This ensures that the motor brake does not inhibit a drive state or a change in the drive state. For example, when the reversing process is detected, the internal combustion engine may still be in its thrust state and switch to the drive state during the reversing process. The motor brake is then deactivated before this change, for example.

In a further embodiment of the method, it is provided that the motor brake is activated depending on a motor speed. This allows the motor brake to be activated as required, for example when the maximum speed is exceeded in a thrust state. This also protects the powertrain. For example, a hydrostat in a hydrostatically power-split transmission in the powertrain can be reliably protected against damage caused by the motor brake. For example, the strength of the motor brake can also be adjusted depending on the motor speed. Alternatively, or additionally, the motor brake can also be activated manually.

In a further embodiment of the method, it is provided that the motor brake adjusts a damper flap in an exhaust system. This allows the back pressure in the respective combustion chambers of the internal combustion engine to be increased. For example, the back pressure against which the pistons must push gas can be increased, thereby also increasing the deceleration caused by the internal combustion engine. Such a motor brake is simple, reliable, and efficient. However, unless it is deactivated in good time by fully opening the damper flap, such a motor brake can significantly impede the combustion process when switching to drive state. This obstruction is reliably prevented by the control method of the motor brake.

In a further embodiment of the method, it is provided that a variable valve control is controlled by the motor brake. The variable valve control allows for particularly powerful and, alternatively or additionally, particularly variable adjustment of deceleration using the motor brake. For example, variable valve control can be used to delay the closing and opening times of individual valves. However, unless the motor brake is disengaged in good time to restore the valve timing optimized for the combustion process, the combustion process may also be significantly impeded.

In a further embodiment of the method, it is provided that the powertrain is designed as a hydrostatically power-split powertrain. A hydrostatically power-split powertrain features a hydrostatic transmission. This allows the transmission ratio of a transmission to be adjusted continuously. During the reversing process, the hydrostat is then usually pivoted, which can, however, lead to particularly high pressure on the internal combustion engine. Overall, in a hydrostatic power-split powertrain, the reversing process can quickly require a large drive power from the internal combustion engine, which is then possible without restriction due to the method, even if the motor brake has been used previously.

In a further embodiment of the method, it is provided that the deactivation time is determined relative to a pivot angle of a hydrostat of the powertrain. The hydrostat can have a variable displacement pump and a constant displacement pump. The pivot angle may correspond to an adjustment of the variable pump. This allows the deactivation time to be adjusted to an actual power demand and, alternatively or additionally, to a transmission ratio. This allows the motor brake to be used for a particularly long time, enabling particularly strong deceleration before the reversing process. For example, the motor brake may not yet be completely switched off at the start of the injection process, but the power required for the reversing process can still be provided in full at any time.

In a further embodiment of the method, it is provided that the deactivation time is determined relative to a time at which a currently closed clutch is disengaged during the reversing process. This makes timing the deactivation of the motor brake particularly easy and precise. The clutch may be a clutch of the reversing device. The exact time when the clutch is disengaged can be determined as soon as the reversing process has been detected. For example, the reversing process can only be detected by this disengaging. Nevertheless, the motor brake can still be deactivated in good time, since drive power may only be required when another clutch is engaged, for example by closing this additional clutch of the reversing device. The disengaging may correspond to the beginning of the opening of this clutch.

Alternatively, or additionally, the deactivation time is determined relative to a time when a clutch is pre-filled for the reversing process. Pre-filling can be the initial printing of a clutch before it is closed. Pre-filling closes a fan gap at the clutch, for example, and fills a piston with oil. The respective lamellas of the clutch can then almost be in contact. The pre-filled clutch can be the further clutch of the reversing device, which is closed during the reversing process after the other clutch has been disengaged. This also makes it particularly easy and accurate to time the deactivation of the motor brake.

In a further embodiment of the method, it is provided that the deactivation time is determined depending on transmission dynamics during the reversing process. The transmission dynamics may be a required change in transmission ratio, for example through a hydrostatic transmission. The transmission dynamics can also correspond to a required acceleration during the reversing process in the opposite direction. For example, it can be taken into account that, in the case of high transmission dynamics, high drive power must be provided by the internal combustion engine at an early stage, which can be ensured by deactivating the motor brake at the appropriate time.

A second aspect relates to a controller for controlling a motor brake of an internal combustion engine of a powertrain of a motor vehicle. The controller may be designed to carry out the method according to the first aspect. The respective advantages and further features can be found in the description of the first aspect, wherein embodiments of the first aspect also constitute embodiments of the second aspect and vice versa. The controller may, for example, be implemented by a transmission control device, such as a TCU, or a vehicle control unit, such as a VCU.

The controller has a detection device which is designed to detect a reversing process. The detection device can, for example, be connected to respective sensors of the motor vehicle in order to detect the reversing process depending on respective sensor signals and, alternatively or additionally, respective vehicle status information. The controller has a determination device which is designed to determine a deactivation time for the motor brake depending on the detected reversing process. For example, the determination device can be designed as a microchip and calculate the deactivation time depending on the time elapsed during the reversing process. The controller has a deactivation device which is designed to deactivate the motor brake at the deactivation time if the motor brake is activated. The deactivation device can, for example, transmit a corresponding control signal to the motor brake at the deactivation time. In addition, the deactivation device can be designed to deactivate the motor brake when the speed falls below a minimum speed. The minimum speed can be fixed or dependent on the gear.

In addition, the controller may comprise an activation device designed to activate the motor brake. The activation device can activate the motor brake, for example, depending on a motor speed, acceleration, and alternatively or additionally a desired driving speed. As a prerequisite for activating the motor brake, it may be necessary for the internal combustion engine to be in a thrust state.

### BRIEF DESCRIPTION OF THE FIGURES

FIG. 1 schematically illustrates a method for controlling a motor brake of an internal combustion engine of a powertrain of a motor vehicle.

FIG. 2 schematically illustrates a controller for controlling the motor brake of the internal combustion engine of the powertrain of the motor vehicle using the method according to FIG. 1.

### DETAILED DESCRIPTION OF EMBODIMENTS

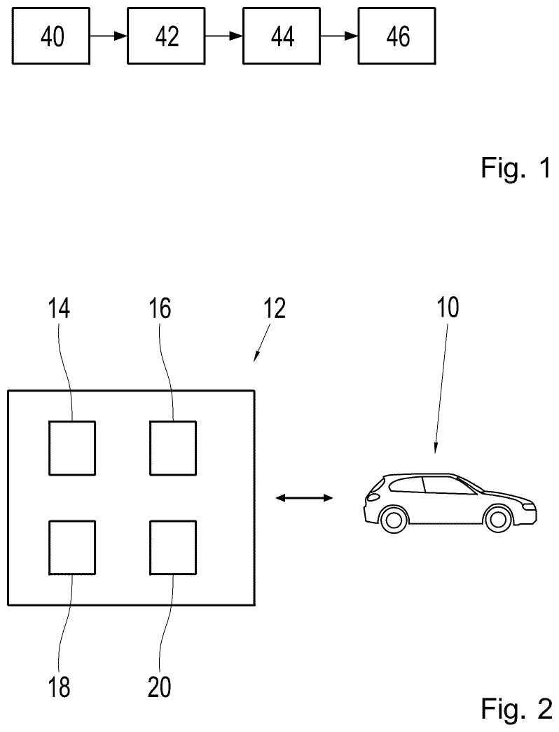

FIG. 1 schematically illustrates a method for controlling a motor brake of an internal combustion engine of a powertrain of a motor vehicle 10, which is shown together with a controller 12 in FIG. 2. The controller 12 is shown in FIG. 2 next to the motor vehicle 10, but in the example shown, it is actually integrated into the transmission control of the motor vehicle 10. In the example shown, the powertrain is designed as a hydrostatic power-split powertrain. The figure shows a motor vehicle 10 designed as a passenger car, which in another embodiment is designed as a work machine.

In a first step 40, an activation device 14 of the controller 12 activates the motor brake in the motor vehicle 10 in dependence on a motor speed in a thrust state of the internal combustion engine in order to increase the deceleration of the motor vehicle 10 caused by the internal combustion engine. This prevents the maximum speed from being exceeded, which could damage a hydrostatic drive in the powertrain. The motor brake is formed by a damper flap in an exhaust system of the internal combustion engine. This damper flap is adjusted when the motor brake is activated in order to reduce or even completely close a passage opening in the exhaust system. This increases the back pressure against which the respective pistons of the internal combustion engine must push out gases. Depending on the desired deceleration caused by the internal combustion engine, the damper flap is closed further or less. When the motor brake is deactivated, there is a time deceleration because the damper flap must be returned to a position in which the exhaust system is fully open through the damper flap.

In step 42, a reversing process of the motor vehicle 10 is detected. For this purpose, the controller 12 has a detection device 16. The detection device 16 is designed to detect the reversing process based on the actuation of a direction selector lever of the motor vehicle 10 by a driver of the motor vehicle 10.

In step 44, a deactivation time for the motor brake is determined depending on the detected reversing process. For this purpose, the controller 12 has a determination device 18. The deactivation time is determined by first determining a time at which a clutch of a reversing device of the powertrain is pre-filled during the reversing process. Pre-filling is the initial filling of the clutch, which is adjusted from an open state to a closed state when the direction of travel is changed. This time is a reference time for deactivating the motor brake. During pre-filling, a fan play on the clutch is released and a piston, which is used to adjust the clutch, is filled with oil. The deactivation time is determined relative to the reference time. Based on this reference time, a start time for an injection process in the internal combustion engine during the reversing process is determined. The deactivation time is determined as a time which occurs after a deceleration time between the deactivation of the motor brake and the admissibility of the start of an injection process in the internal combustion engine before this start time of the injection process. In addition, in one embodiment, a time tolerance may be provided as an additional time interval between the deactivation time and the start of the injection process in order to ensure that the motor brake is actually switched off completely by opening the damper flap in the exhaust system completely and in good time, even in the event of a slight time deviation in the control.

In step 46, the motor brake is deactivated at the deactivation time determined in this way by means of a deactivation device 20 of the controller 12. To this end, the deactivation device 20 transmits a control signal to an adjustment motor to reset the damper flap and thus completely open the exhaust system through the damper flap. This makes use of the fact that the sequence of the reversing process is known. It is known or can be determined how long it will take in the current driving situation before the internal combustion engine is loaded by the reversing process and the closed clutch is engaged. With this information, and since a deceleration time is known until the motor brake is actually deactivated by completely resetting the damper flap, the deactivation time of the motor brake can be calculated and thus determined so that the motor brake is no longer effective at the time of clutch reversing and the internal combustion engine can inject fuel unrestrictedly through the motor brake. This prevents excessive motor pressure, i.e., in the example shown, a reduction in motor speed, caused by the reversing process, and means that the dynamic demand on the powertrain, Le., in the example shown, an acceleration demand, does not have to be reduced in order to protect the internal combustion engine from excessive pressure. This allows acceleration from the reversing process into a now changed opposite direction of travel with a very continuous output speed curve.

### REFERENCE NUMBERS

10 Motor vehicle
12 Controller
14 Activation device
16 Detection device
18 Determination device
20 Deactivation device
40 Step: Activation of the motor brake
42 Step: Detection of a reversing process
44 Step: Determination of a deactivation time
46 Step: Deactivation of the motor brake at the deactivation time

1. A method for controlling a motor brake of an internal combustion engine of a powertrain of a motor vehicle (10), comprising at least the following steps:
activating (40) the motor brake;
detecting a reversing process;
determining a deactivation time for the motor brake depending on the detected reversing process; and
deactivating the motor brake at the deactivation time.

2. The method according to claim 1, wherein determining the deactivation time of the motor brake depends on a deceleration time between the deactivation of the motor brake and an admissibility of starting an injection process in the internal combustion engine, and in dependence on a start time of the injection process in the internal combustion engine during the reversing process.

3. The method according to claim 1, wherein determining the deactivation time of the motor brake depends on a deactivation delay time of the motor brake.

4. The method according to claim 1, wherein the deactivation time is determined such that the internal combustion engine is still in a thrust state when the motor brake is deactivated (46).

5. The method according to claim 1, wherein the activation of the motor brake takes place depending on a motor speed.

6. The method according to Claim 1, comprising using the motor brake to adjust a damper flap in an exhaust system.

7. The method according to claim 1, comprising controlling a variable valve control by the motor brake.

8. The method according to claim 1, wherein the powertrain is configured as a hydrostatically power-split powertrain.

9. The method according to claim 8, comprising determining the deactivation time relative to a pivot angle of a hydrostat of the powertrain.

10. The method according to claim 1, comprising determining the deactivation time relative to at least one of the following times:
(i) a time when a currently closed clutch is disengaged during the reversing process; and
(ii) a time when a clutch is pre-filled for the reversing process.

11. The method according to claim 1, comprising determining the deactivation time based on a transmission dynamics during the reversing process.

12. A controller for controlling a motor brake of an internal combustion engine of a powertrain of a motor vehicle (10), the controller (12) comprising:
a detection device (16) configured to detect a reversing process;
a determination device (18) configured to determine a deactivation time of the motor brake as a function of the detected reversing process; and
a deactivation device (20) configured to determine that the motor brake is activated and to deactivate the motor brake at the deactivation time.
